(19) United States
(12) Patent Application Publication
(10) Pub. No.: US 2026/0287462 A1
(43) Pub. Date: Sep. 24, 2026

(54) LEAK DETECTION BASED ON ACOUSTIC AND PRESSURE SIGNALS

(71) Applicant: Neptune Technology Group LLC, Tallassee, AL (US)

(72) Inventors: Wyatt Edward Northrup, Auburn, AL (US); Jeffrey M. Fowler, Lawrenceville, GA (US)

(21) Appl. No.: 19/576,174

(22) Filed: Mar. 24, 2026

Related U.S. Application Data
(60) Provisional application No. 63/776,405, filed on Mar. 24, 2025.

(51) Int. Cl. G01M 3/24

(52) U.S. Cl. CPC G01M 3/243

(57) ABSTRACT

A device and a method are described in which an acoustic and pressure-based leak detection system is provided. A meter includes: an inlet attachable to a piping system; an outlet attachable to the piping system; a passageway between the inlet and the outlet; an acoustic sensor; a pressure sensor; and a detector, wherein the detector is configured to: receive a first signal from the pressure sensor; receive a second signal from the acoustic sensor; select an acoustic analytics process based on a pressure value associated with the first signal; analyze the second signal based on the acoustic analytics process; detect a leak in the piping system based on the analysis; and generate and transmit an alert in response to detecting the leak in the piping system.

### CROSS-REFERENCE TO RELATED APPLICATION

This application claims the benefit of U.S. Provisional Patent Application No. 63/776,405, filed Mar. 24, 2025, the contents of which are incorporated by reference herein.

### BACKGROUND

Utility companies and other entities operate distribution systems for various resources (e.g., water, gas, electricity, chemicals, etc.) to deliver these resources to customers connected to the distribution systems. A meter may be used at each point where the resource is removed and/or provided from the distribution system to a customer to measure usage. Each meter includes or may be coupled to a radio transmitter that has an integral or external antenna. Many metering systems use wireless communications to report meter readings to a backend system via a communication network.

### SUMMARY

Meters that measure usage of a resource, such as a utility resource (e.g., water, gas, electricity, etc.) or another type of resource (e.g., chemical, etc.) are widely used. Further, meters have been combined with electronic components to facilitate communication between the meters and backend systems via a network. For example, a meter interface unit (MIU) may include a transmitter that is configured to wirelessly transmit usage information and other types of information (e.g., leak information, reverse flow detection, etc.). The MIU may also include a receiver that is configured to wirelessly receive information and commands. The meter and the MIU may be a part of an automated meter reading (AMR) system, such as an AMR system associated with a water utility company, an advanced metering system (AMS), an advanced meter infrastructure (AMI), or another type of architecture associated with a utility company or another entity.

Leak detection in a distribution system can be accomplished by different methods. For example, one approach includes monitoring flow consumption and communicating an alert when the time series of flow consumption values deviate from a normative value. A meter can count a number of consecutive time periods in which the meter measures flow consumption in excess of a first threshold value. The meter can transmit an alert when the number of consecutive time periods exceeds a second threshold value. This approach can be effective for relatively large leaks that are downstream from the meter.

A second approach relies on a sound generated or produced by a leak. For example, the meter captures the sound using an acoustic detector and analyzes the acoustic signal. The sound of the leak may be detectable regardless of whether the leak is located upstream or downstream from the meter. Additionally, the leak may be identified even when the flow consumption associated with the leak is below a reliable detection level of the meter. The location of the leak may be estimated or deduced based on concurrent analysis of a plurality of acoustic signals, particularly if the acoustic signals are time-correlated. This approach may produce false alerts due to detection of sounds produced from noise sources other than leaks. For example, noise sources stemming from a pump, a hydraulic motor, a passing vehicle, an earthquake, a train, activity at a construction site, or another type of noise source may lead to a false leak detection and consequently false alerts.

A third approach may use a pressure sensor that monitors a fluid pressure at one or multiple points in the distribution system. When the pressure sensor is associated with a flow consumption meter, a normal flow consumption event may lead to a drop in pressure, in which a leak should not be detected. However, a drop in pressure not associated with a flow consumption event may indicate a leak upstream from the flow consumption meter. The third approach can be used to determine a general area of a pressure anomaly, but may not provide detailed information about the location of the leak. Additionally, the third approach is not sensitive to detecting minor leaks. That is, a small leak may not appreciably reduce the line pressure.

According to exemplary embodiments, an acoustic and pressure-based leak detection system is described. According to an exemplary embodiment, a meter provides the acoustic and pressure-based leak detection system. For example, a water meter or another type of flow meter may provide the acoustic and pressure-based leak detection system. The meter can include a combination of pressure sensors and acoustic sensors. Example acoustic sensors include active sensors and passive sensors. An active acoustic sensor transmits and receives acoustic energy, while a passive acoustic sensor receives acoustic energy and does not transmit acoustic energy. Acoustic sensors can include sensors that process acoustic energy in the ultrasonic frequency range (e.g., approximately 20 kilohertz (kHz) and above), the audible range (e.g., approximately 20 hertz (Hz) to 20 kHz), the infrasound range (e.g., approximately 20 Hz and below), or any combination thereof.

According to an exemplary embodiment, the acoustic and pressure-based leak detection system includes a detection circuit or a signal chain (referred to herein as simply a detector) that performs both acoustic signal analytics and pressure signal analytics directed to leak detection. According to an exemplary embodiment, the detector may associate or correlate an acoustic signal with a pressure signal to determine whether or not there is a leak. According to another exemplary embodiment, the detector may determine whether or not there is a leak based on an acoustic signal or a pressure signal. According to various exemplary embodiments, the leak may relate to a pipe or conduit directly or indirectly coupled to the meter, as described herein.

According to an exemplary embodiment, the detector may analyze an acoustic signal. When the result of the analysis indicates the acoustic signal is inconsistent with a leak, the detector or another component of the meter may not generate an alert. However, when the result of the analysis indicates a leak, the detector or another component of the meter may generate an alert. According to other examples, when the result of the analysis indicates that the acoustic signal is weakly indicative of a leak, the detector may analyze a pressure signal. The pressure signal can be generated by a pressure sensor configured to measure a pressure value. According to an exemplary embodiment, the detector may include comparing the pressure signal to a threshold pressure value. The threshold pressure value can be, for example, a value of absolute pressure (e.g., as measured in units of psia), a value of gauge pressure (e.g., as measured in units of psig), a value of differential pressure (e.g., as measured in units of psid), a value of a change in pressure (e.g., ∆P), or any of these. For example, the threshold pressure value may be used to determine whether there is a pressure drop indicative of a leak or not (e.g., a normative flow consumption event versus a pressure not attributable to a normative flow consumption event, etc.). Based on the result of the comparison, when the measured pressure does not satisfy the threshold pressure value, the detector or another component of the meter may determine the absence of a leak and not generate an alert. Conversely, when the pressure does satisfy the threshold pressure value, the detector or another component of the meter may determine the presence of a leak and generate an alert. The measured pressure satisfying the threshold pressure value can include, for example, a measured gauge pressure of a resource not matching the threshold pressure value within a specified margin. In another example, the measured pressure satisfying the threshold pressure value can include a measured change in pressure of a resource over time exceeding a threshold change in pressure value.

According to another exemplary embodiment, the detector may analyze the acoustic signal based on the pressure signal, temperature, and other context information, or a subset of correlated information, as described herein. For example, a change in pressure may change a peak frequency, amplitude, and/or another characteristic of a detected acoustic signal. According to such an embodiment, the detector or another component of the meter may distinguish between a noise source associated with a leak and a noise source not attributable to a leak but some other type of acoustic anomaly. Additionally, the detector may analyze other types of information, such as temperature, for evaluating the acoustic signature (e.g., one or multiple spectral characteristics of an acoustic signal) to better identify a leak and distinguish the leak from other noise anomalies. In this way, multiple criteria that may correlate and may have an interrelationship may be used to detect the presence or the absence of a leak.

According to an exemplary embodiment, the detector may store information that correlates multiple acoustic signatures at different pressure values or ranges, and at different temperatures values or ranges that may enable the detector to estimate a likelihood of the presence of a leak. For example, a peak frequency and/or another spectral characteristic of an acoustic signal of a leak may increase with line pressure, while the peak frequency and/or another spectral characteristic of an acoustic signal of a non-leak may not change with line pressure, or may fluctuate by an amount larger or smaller than expected for an actual leak. According to another example, a measured temperature may be useful in discerning the presence or absence of a leak. For example, materials that may contract or expand with temperature changes may open, widen, tighten, or change the form of the leak. In this regard, a leak caused by deterioration, rusting, or other form of degradation associated with a pipe or conduit may respond differently to changes in temperature and/or line pressure than a leak caused for other reasons, such as intrusion of roots (e.g., trees, bushes, or the like) or poor joints. Additionally, or alternatively, the composition of the pipe may impact the detection of a leak. For example, a leak in a section of pipe composed of PVC may respond differently than a leak in a section of pipe composed of iron or another material.

Depending on the size of the leak, the leak may or may not be associated with a pressure drop. As such, according to an exemplary embodiment, the threshold pressure value may be dynamic. For example, the threshold pressure value may be adjusted based on an analysis of acoustic data collected during a time period. As an example, acoustic data determined to be indicative of a leak, the threshold pressure value may be evaluated and adjusted. According to an exemplary embodiment, a risk of false alerts may be mitigated by monitoring flow consumption at multiple meters. For example, a hydraulic model may be used.

According to an exemplary embodiment, an alert for a detected leak may include data characteristics of the leak. For example, the data may include a frequency spectrum of the leak, a location of the leak, or both. According to an exemplary embodiment, the meter may transmit the alert to a head end system or another suitable backend system by means of a communication channel.

In view of the foregoing, the acoustic and pressure-based leak detection system may use acoustic and pressure signals for leak detection. For example, in contrast to meters that use acoustic or pressure signals, the combined acoustic and pressure-based leak detection system may provide more accurate leak detection as well as information about other aspects of the leak, such as location.

In general, one innovative aspect of the subject matter described in this specification can be embodied in a meter including: an inlet attachable to a piping system; an outlet attachable to the piping system; a passageway between the inlet and the outlet; an acoustic sensor; a pressure sensor; and a detector. The detector is configured to: receive a first signal from the pressure sensor; receive a second signal from the acoustic sensor; select an acoustic analytics process based on a pressure value associated with the first signal; analyze the second signal based on the acoustic analytics process; detect a leak in the piping system based on the analysis; and generate and transmit an alert in response to detecting the leak in the piping system.

In general, one innovative aspect of the subject matter described in this specification can be embodied in a system for monitoring leakage in a piping system, the system including: a pressure sensor; an acoustic sensor; and a computing device communicably coupled to the pressure sensor and the acoustic sensor, the computing device configured to perform operations including: receiving a first signal from the pressure sensor; receiving a second signal from the acoustic sensor; selecting an acoustic analytics process based on a pressure value associated with the first signal; analyzing the second signal based on the acoustic analytics process; detecting a leak in the piping system based on the analysis; and generating and transmitting an alert in response to detecting the leak in the piping system.

In some implementations, the detector is further configured to: determine a location of the leak relative to the meter based on a direction of sound detected by the acoustic sensor.

In some implementations, the acoustic analytics process includes comparing spectral analysis of the second signal to a predicted spectral analysis of the second signal. The predicted spectral analysis of the second signal is based on the pressure value.

In some implementations, detecting the leak includes selecting a degree of confidence of the leak from a ternary determination of degrees of confidence or a quaternary determination of degrees of confidence.

In some implementations, the detector is configured to select the acoustic analytics process based on the pressure value and a temperature value associated with the first signal.

In some implementations, the detector is further configured to calculate a flow measurement value for flow of a resource through the meter.

In some implementations, analyzing the second signal based on the acoustic analytics process is responsive to determining that the pressure value associated with the first signal does not satisfy criteria for matching an expected pressure value.

In some implementations, the alert includes data pertaining to the analysis of the second signal.

In some implementations, the meter includes a water meter.

In some implementations, the acoustic sensor includes an ultrasonic transducer.

In general, one innovative aspect of the subject matter described in this specification can be embodied in a method for monitoring leakage in a piping system, the method including: receiving, by a detector of a meter, a first signal from a pressure sensor. The meter includes an inlet attachable to the piping system, an outlet attachable to the piping system, and a passageway between the inlet and the outlet. The method includes: receiving, by the detector, a second signal from an acoustic sensor; selecting, by the detector, an acoustic analytics process based on a pressure value associated with the first signal; analyzing, by the detector, the second signal based on the acoustic analytics process; detecting a leak in the piping system based on the analysis; and generating and transmitting, by the detector, an alert in response to detecting the leak in the piping system.

In some implementations, the method further includes: determining, by the meter, a location of the leak relative to the meter based on a direction of sound detected by the acoustic sensor.

In some implementations, the acoustic analytics process includes comparing spectral analysis of the second signal to a predicted spectral analysis of the second signal. The predicted spectral analysis of the second signal is based on the pressure value.

In some implementations, detecting the leak includes: selecting, by the detector, a degree of confidence of the leak from a ternary determination of degrees or a quaternary determination of degrees of confidence.

In some implementations, the method includes: calculating, by the detector, a flow measurement value for flow of a resource through the meter.

In some implementations, the method includes: selecting, by the detector, the acoustic analytics process based on the pressure value and a temperature value associated with the first signal.

In some implementations, analyzing the second signal based on the acoustic analytics process is responsive to determining that the pressure value associated with the first signal does not satisfy criteria for matching an expected pressure value.

In some implementations, the meter includes a water meter.

In some implementations, the acoustic sensor includes an ultrasonic transducer.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 is a diagram illustrating an exemplary embodiment of a meter that includes an acoustic and pressure-based leak detection system.

FIG. 2 is a diagram illustrating another exemplary embodiment of a meter that includes the acoustic and pressure-based leak detection system.

FIG. 3 is a diagram illustrating exemplary components of a meter that provides the acoustic and pressure-based leak detection system.

FIG. 4 is a diagram illustrating an exemplary process of the acoustic and pressure-based leak detection system.

FIG. 5 is a diagram illustrating another exemplary process of the acoustic and pressure-based leak detection system.

### DETAILED DESCRIPTION

The following detailed description refers to the accompanying drawings. The same reference numbers in different drawings may identify the same or similar elements. Also, the following detailed description does not limit the invention.

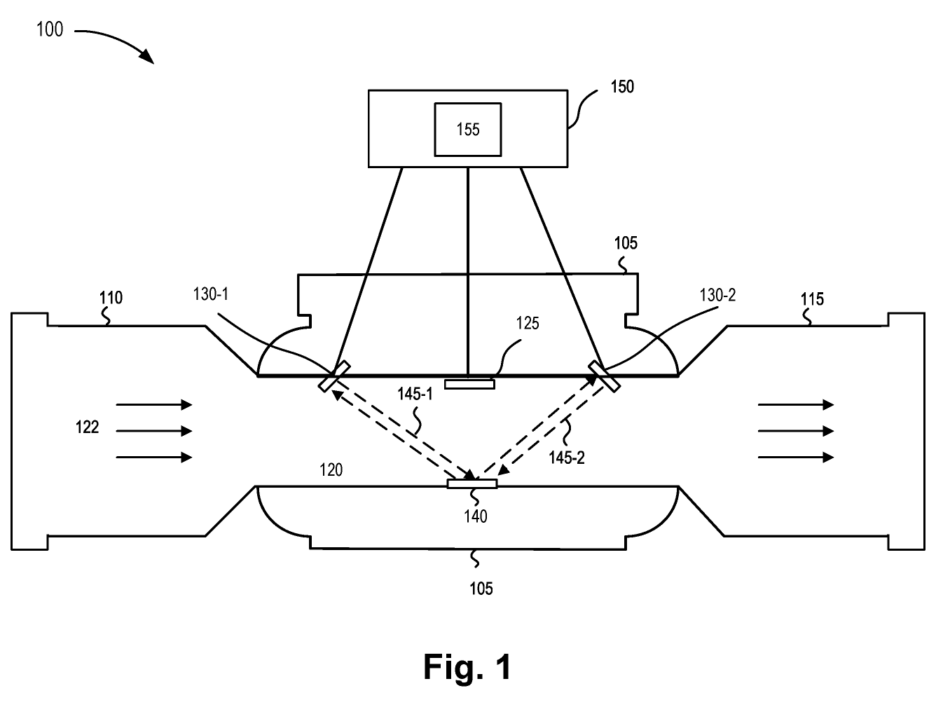

FIG. 1 is a diagram of an exemplary meter 100 that includes an acoustic and pressure-based leak detection system. As illustrated, meter 100 may include a casing 105, an inlet 110, an outlet 115, a passageway, or pathway 120, a pressure sensor 125, transducers 130-1 and 130-2 (also referred to collectively as transducers 130, and generally and individually as transducer 130), a mirror 140, and a detector 150. According to other exemplary embodiments, meter 100 can include additional, fewer, and/or different elements, as described herein. For example, meter 100 may be implemented as a flow consumption meter, such as an ultrasonic flow meter.

The meter 100 can be attachable to a piping system. In some examples, the meter 100 is installable in line with a piping system. For example, the inlet 110 and the outlet 115 can be attachable to the piping system, such that a resource flowing through the piping system flows through the pathway 120. The disclosed systems and techniques can be implemented to monitor flow within the piping system, to monitor leakage in the piping system, or both.

For purposes of description, although not illustrated in FIG. 1, meter 100 can include other components or elements, such as a processor, a controller, or another type of control logic, an MIU, an antenna, a power source (e.g., a battery), a temperature sensor, a memory, and so forth. According to an exemplary embodiment, meter 100 can be implemented as a water meter. According to another exemplary embodiment, meter 100 can be another type of meter. According to still another exemplary embodiment, another type of apparatus can include the acoustic and pressure-based leak detection system.

Meter 100 can be implemented as a flow meter. For example, meter 100 can be situated in a distribution network and configured to measure the flow of a resource (e.g., water, gas, oil, chemical, or the like), usage or consumption of the resource, and/or the like, and leak detection and localization, as described herein.

Casing 105 can be a housing that encases various elements of meter 100. Inlet 110 and outlet 115 can operate as an input and an output, respectively, relative to a flow of a resource, such as water, for example. Arrows represent a direction of resource flow 122 relative to meter 100. Pathway 120 can provide a passageway between inlet 110 and outlet 115. Inlet 110, outlet 115, and pathway 120 can be implemented as a unitary piece.

Pressure sensor 125 can include a sensor that measures pressure. For example, pressure sensor 125 can be implemented as a gauge pressure sensor, a differential pressure sensor, another type of sensor that can measure the pressure of the resource, or a combination or sub-combination thereof. For example, pressure sensor 125 can measure the pressure in water or another type of resource associated with resource flow 122. The number and the location of pressure sensor 125 are exemplary. For example, meter 100 can include multiple pressure sensors 125. Additionally, or alternatively, pressure sensor 125 can be situated in a location different from that illustrated in FIG. 1, such as in inlet 110 and/or outlet 115. As illustrated, pressure sensor 125 can be communicably coupled to detector 150.

Transducer 130 can be a device that converts acoustic signals to electrical signals and vice versa (i.e., electrical signals to acoustic signals). Acoustic signals can include acoustics signals in the ultrasonic range (e.g., 20 kHz and higher), in the audible range (e.g., 20 Hz to 20 kHz), and in the infrasound range (e.g., 20 Hz and lower). In some examples, the transducer 130 is an ultrasonic transducer that is configured to process acoustic energy in the ultrasonic range. In some examples, the transducer 130 is configured to process acoustic energy in at least a portion of the ultrasonic range and in at least a portion of the audible range. For example, the transducer 130 can be configured to detect and process acoustic energy at frequencies of 20 kHz and higher and at frequencies of 10 Hz to 2.5 kHz.

According to some exemplary implementations, transducer 130 can include a piezoelectric transducer or a capacitive transducer. The transducer 130-1 can be an active sensor that generates and sends a pulse or pulses, for example, along a signal path 145-1 through the pathway 120 (e.g., water, etc.) to transducer 130-2, which can receive the pulse or pulses, as described herein and illustrated in FIG. 1. Additionally, or instead, transducer 130-2 can be an active sensor that generates and sends a pulse or pulses along a signal path 145-2 through the pathway 120 to transducer 130-1, which can receive the pulse or pulses, as described herein and illustrated in FIG. 1. The signal paths 145-1 and 145-2 each reflect off of the mirror 140. When a resource is in the pathway 120, the signal paths 145-1 and 145-2 pass through the resource. In some examples, the transducers 130-1, 130-2, or both can be passive sensors that are configured to receive acoustic energy and are not configured to transmit acoustic energy.

The material and geometry of the transducer 130 is selected such that the transducer can effectively sample an acoustic signal for leak detection while also meeting requirements for flow measurements. In some implementations, the transducer 130 is a piezoelectric transducer having a cylindrical shape. A cylindrical piezoelectric transducer can support multiple mechanical vibration modes, such as a radial mode and a thickness mode (i.e., axial mode). The use of a cylindrical piezoelectric transducer for flow sensing leverages resonance/anti-resonance at higher frequencies near the thickness mode (e.g., compression and expansion along the axial direction). The cylindrical piezoelectric transducer also responds near the radial mode (e.g., compression and expansion perpendicular to the axial direction), and can therefore detect lower frequencies near the radial mode, such as those that may be relevant for leak detection.

For a cylindrical piezoelectric transducer, the ratio of diameter to axial length can be referred to as an aspect ratio. The aspect ratio affects which vibration modes are excited, as well as the resonance frequencies. The aspect ratio therefore affects the frequencies which the transducer most efficiently detects and/or transmits. Increasing the aspect ratio generally shifts the dominant resonance to lower radial frequencies. In some examples, a diameter of the cylindrical transducer is greater than an axial height of the cylindrical transducer, such that the aspect ratio is 1.0 or greater. In some examples, the piezoelectric transducer has a shape other than cylindrical, such as a ring shape.

According to an exemplary process, meter 100 can use transducers 130 to make flow measurements, as described herein. Additionally, according to an exemplary process, meter 100 can use one or both transducers 130 to detect leaks.

To perform flow monitoring, detector 150 can drive transducers 130 to generate and transmit a signal including the pulse or pulses, as described herein. In some examples, the transducer 130-1 and the transducer 130-2 both transmit and receive signals. The signal path 145-1 is in a downstream direction of the resource while the signal path 145-2 is in an upstream direction of the resource. The flow of the resource affects the time of flight (TOF) of the signals as they pass through the pathway 120. A difference between the TOF of an ultrasonic signal transmitted from the transducer 130-1 to the transducer 130-2 and the TOF of an ultrasonic signal transmitted from the transducer 130-2 to the transducer 130-1 can be used to measure fluid flow rate of the resource through the pathway 120. Thus, the elapsed time between when the signal is sent from one transducer 130 to another transducer 130, and vice versa, can enable detector 150 to calculate a differential TOF.

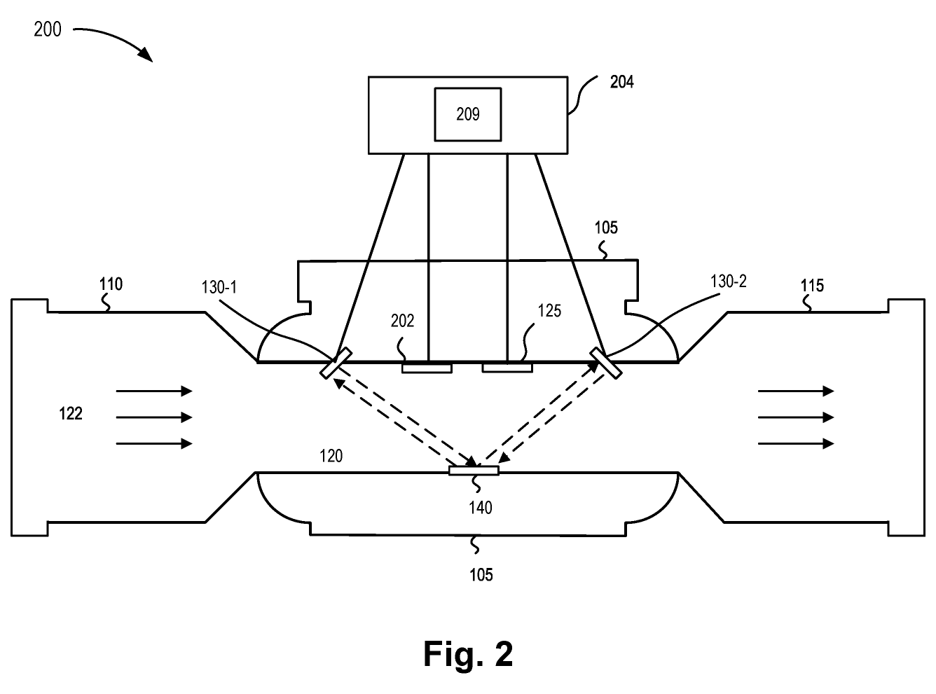

According to an exemplary embodiment, detector 150 can include a digital signal processor (DSP) 155 that can process signals received by the transducers 130. For example, the DSP can calculate a TOF of each signal, and calculate a differential TOF based on the difference between the TOF of the two signals. The differential TOF can be used to calculate the velocity of resource flow 122 (e.g., in units of meters per second), a volumetric flow rate (e.g., in units of liters per second or gallons per minute), a mass flow (e.g., in units of kilograms per second or pounds per hour), total volume (e.g., in units of liters or gallons), consumption, and the like. Operations of the DSP 155 are further described with reference to FIG. 2.

Detector 150 can include a clock (not illustrated) as a time reference. During a flow rate monitoring process, the detector 150 can be configured to sample the ultrasonic signals at a higher rate relative to the sampling rate used for detecting noise indicative of a leak, given the disparity between the ultrasonic frequency range and frequency noise range associated with a leak or another type of acoustic anomaly.

In some examples, the sampling rate for flow monitoring is at least double the Nyquist frequency of the highest relevant frequency for flow detection. For example, for a 2 MHz transducer, the sampling rate may be approximately 8 MHz (e.g., 6 MHz or greater, 16 MHz or less). For a 1 MHz transducer, the sampling rate may be approximately 4 MHz (e.g., 3 MHz or greater, 8 MHz or less).

In some examples, the sampling rate for leak detection is at least double the Nyquist frequency of the highest relevant frequency for leak detection. For example, for leak detection within a range of audio frequencies with an upper end of 128 Hz, the sampling rate may be approximately 512 Hz (e.g., 256 Hz or greater, 1 kHz or less). For leak detection within a range of audio frequencies with an upper end of 1 kHz, the sampling rate may be approximately 4 kHz (e.g., 2 kHz or greater, 8 kHz or less). For leak detection within a range of audio frequencies with an upper end of 2.5 kHz, the sampling rate may be approximately 10 kHz to reduce aliasing. In some examples, for leak detection within a range of audio frequencies with an upper end of 2.5 kHz, the sampling rate may be 5 kHz or greater or 20 kHz or less.

The detection frequency of ultrasonic sensors can be limited by high impedance at the lowest frequencies (e.g., <500Hz). Therefore, in some implementations, the detector 150 can include low frequency amplifiers to improve the detection of acoustic signals in the audible range.

Detector 150 can output flow information to an MIU (not illustrated) of meter 100. The MIU can transmit the flow information to a backend device via a network. Detector 150 can store the flow information in a memory.

In addition to, or instead of, being used for flow monitoring, the transducer 130 of meter 100 can be used to detect a leak, as described herein. In some examples, a leak causes sounds such as hissing, rushing, or whistling, due to fluid escaping from pressurized pipes. The sounds may include frequencies in the audible range, frequencies in the ultrasonic range, or both. In some examples, a leak can cause vibration that generates acoustic energy in the infrasound range. The transducer 130 can detect the sounds and/or vibrations caused by the leak that fall within the frequency bandwidth of the transducer 130.

For example, one or multiple transducers 130 can be used to detect acoustic signals (e.g., noise) that are generated from the piping system and/or the environment. The transducers 130 can convert the acoustic signals to electrical signals and provide the electrical signals to the detector 150. The detector 150 can determine whether the signals are indicative of the absence or presence of a leak in a pipe or piping system connected to the meter. One or more of the transducers 130 can listen for acoustic signals that are generated by acoustic signal or noise sources that are external to the transducers 130, such as leaks. In this regard, the transducers 130 can be used both to measure a flow of a resource based on TOF of a signal generated by the transducers and to detect a leak based on an acoustic signal generated by a leak.

In some examples, the meter 100 can use the transducers 130 to perform flow monitoring and leak monitoring simultaneously. For example, the detector 150 can sample acoustic energy detected by the transducers 130 at a higher rate to perform flow monitoring, and simultaneously sample the transducers 130 at a lower rate to perform leak monitoring.

In some examples, the meter 100 can operate in a flow monitoring mode, and separately operate in a leak detection mode. During the flow monitoring mode, the meter 100 samples the transducers at the higher rate to perform flow monitoring. During the leak detection mode, the meter 100 samples the transducer at the lower rate to perform leak detection. The meter 100 can switch between operating in the flow monitoring mode and in the leak detection mode.

In some cases, the meter 100 can switch between the flow monitoring mode and the leak detection mode based on a schedule. For example, the meter 100 can be configured to perform leak detection for a designated period of time at designated time intervals. In an example, the meter 100 performs leak detection for a period of time of 30 minutes at a time interval of once per 24 hours. In this example, the meter 100 may operate according to a schedule in which the meter 100 operates in a flow monitoring mode from 1:30am to 01:00am the next day. The meter 100 then switches at 1:00am from the flow monitoring mode to the leak detection mode. The meter 100 switches back from the leak detection mode to the flow monitoring mode at 1:30am, and the cycle repeats. Other time periods and intervals can be implemented, such as performing leak detection for 10 minutes at a time interval of once per 12 hours, performing leak detection for one hour every 16 hours, etc.

In some cases, the meter 100 can switch between the flow monitoring mode and the leak detection mode based on sensor data. For example, the meter 100 can be configured to switch from the flow monitoring mode to the leak detection mode in response to determining that a quiescence criterion is satisfied, such as detecting flow rate below a threshold flow rate for a predetermined number of flow rate measurements. The meter 100 can switch back to flow monitoring mode based on a schedule (e.g., 30 minutes have elapsed), based on sensor data (e.g., measured pressure rises above a specified threshold), or any combination of these.

In some cases, the meter 100 can switch between the flow monitoring mode and the leak detection mode based on a combination of a schedule and sensor data. For example, the meter 100 can be configured to switch from the flow monitoring mode to the leak detection mode in response to determining that at specified time duration has elapsed since the last leak monitoring measurement and the flow rate being below a threshold flow rate. In an example, the detector 150 can determine that the meter 100 has been operating in the flow monitoring mode for greater than a threshold time period of 24 hours, and that the measured flow rate is below a threshold flow rate, and in response, switch from operating in the flow monitoring mode to operating in the leak detection mode.

In some cases, the meter 100 can switch between the flow monitoring mode and the leak detection mode in response to receiving a command. For example, a connected device may send a signal to the detector 150 instructing to perform a leak detection measurement. The connected device may send the signal in response to a command received from a head-end system.

In an example scenario, the head-end system sends a command to the endpoint to implement a schedule, by which the endpoint will, at 1:00 a.m. each day, send a command to the detector 150 to conduct a leak monitoring measurement. The detector 150 executes the leak monitoring measurement only after a quiescence criterion has been met.

In another example scenario a technician uses a mobile device to send a command to the endpoint, in response to which the endpoint sends a command to the detector 150 to conduct a leak monitoring measurement. The detector executes the leak monitoring measurement without regard to a quiescence criterion.

The number and arrangement of transducers 130 are merely exemplary. For example, according to some exemplary embodiments, the number, configurations, locations, and/or positions of transducers 130 can be different than those illustrated and/or described. By way of further example, while transducers 130 have been illustrated as disposed on a top wall of pathway 120, transducers 130 can be disposed on another wall (e.g., bottom, side, etc.) or radial position associated with pathway 120.

Mirror 140 can be used for flow detection by transducers 130 during normal flow detection. Mirror 140 can be implemented as a steel mirror or another suitable material that can reflect signals. Mirror 140 can be flat, concave, or another configuration.

Detector 150 can include logic or components that provide(s) an exemplary embodiment of the acoustic and pressure-based leak detection system, as described herein. For example, detector 150 can be implemented as an integrated circuit, a system on chip (SOC), a circuit board, or the like.

In some examples, the detector 150 can determine that a pressure value measured by the pressure sensor 125 deviates from a predicted pressure value, and the detector 150 can determine to analyze an acoustic signal measured by one or more of the transducers 130 in response to detecting the deviation. For example, the pressure value may be expected to be within a specified range of pressure values when a resource is passing through the pathway 120. The predicted pressure values can be determined, for example, based on a predicted flow rate of a resource through the pathway 120, based on an expected or measured temperature of the resource, based on a type of the resource, and/or based on other factors. In some examples, the specified range of pressure values is a range of pressure values that is above a threshold pressure value, and the detector 150 can determine to analyze the acoustic signal measured by one or more of the transducers 130 in response to detecting that a measured pressure value is less than the threshold pressure value.

In response to the pressure value deviating from the specified range of values, the detector 150 can determine to analyze the acoustic signals received by the transducers 130 to verify whether the acoustic signals indicate the presence of a leak in the piping system.

In some examples, the detector 150 can use coincidence logic to detect a leak. For example, the detector 150 can determine a high confidence that a leak exists based on a coincidence of both a) the measured pressure deviating from an expected pressure value by at least a threshold amount and b) the transducer 130 detecting audio signals that are indicative of a leak. The detector 150 can determine a lower confidence that a leak exists based on detecting a deviation in pressure with no detected audio signals that are indicative of a leak.

In some examples, the pressure value measured by the pressure sensor 125 can match a predicted pressure value, and the detector 150 can determine not to analyze the acoustic signal(s). For example, the pressure value may remain consistent over time within a threshold tolerance. In response, the detector 150 can determine that a leak is unlikely, and therefore determine not to analyze the acoustic signals detected by the transducer 130.

In some examples, the detector 150 can analyze acoustic signals at a different sampling rate when the pressure value matches an expected pressure value, compared to when the pressure value deviates from the expected pressure value. For example, a first pressure value measured by the pressure sensor 125 can match a predicted pressure value, and the detector 150 can sample the acoustic signals detected by the transducer 130 at a first sampling rate. When a second pressure value measured by the pressure sensors 125 deviates from the predicted pressure value by at least a threshold amount, the detector 150 can sample the acoustic signals detected by the transducer 130 at a second sampling rate that is higher than the first sampling rate.

FIG. 2 is a diagram of an exemplary meter 200 that provides an exemplary embodiment of the acoustic and pressure-based leak detection system. As illustrated, meter 200 can include casing 105, inlet 110, outlet 115, pathway 120, transducers 130, mirror 140, and a detector 204, which includes a DSP 209.

Although not illustrated in FIG. 2, meter 200 can also include other components or elements, such as a processor, a controller, or another type of control logic, an MIU, an antenna, a power source (e.g., a battery), and so forth. According to an exemplary embodiment, meter 200 can be implemented as a water meter. According to another exemplary embodiment, meter 200 can be another type of meter. According to still another exemplary embodiment, another type of apparatus can include the acoustic and pressure-based leak detection system.

Detector 204 can operate similar to that of detector 150, as described. Additionally, DSP 209 can operate similar to that of DSP 155, as described. However, in contrast to detector 150, detector 204 can be communicably coupled to a noise sensor 202 instead of, or in addition to, the transducers 130.

Noise sensor 202 is an acoustic sensor that can detect acoustic energy (e.g., sound, noise) and can be implemented as a microphone, a hydrophone, or the like. The noise sensor 202 can be implemented as a capacitive sensor, an inductive sensor, an optical sensor, a piezo-resistive sensor, a piezo-resistive strain gauge, or another type of acoustic sensor. In some examples, the noise sensor 202 is a passive sensor that detects acoustic energy traveling through the pathway 120.

Noise sensor 202 can have a sensitivity to frequencies indicative of the frequency spectrum of acoustic emissions associated with a leak or another type of anomaly, as described herein. In some examples, a leak causes sounds such as hissing, rushing, or whistling, due to fluid escaping from pressurized pipes. In some examples, a leak can cause turbulence in a resource flowing through a piping system, resulting in noise. The frequency spectrum of noise indicative of the leak may be below the ultrasonic frequency range for flow measurement. In this regard, noise sensor 202 can provide data that represents the acoustic emission indicative of the presence or the absence of the leak or another type of anomaly, as described herein. The number of noise sensors 202 is exemplary and according to other exemplary embodiments, detector 204 can include multiple noise sensors 202 of the same or different types, as described herein. According to other exemplary embodiments, the configurations, locations, and/or positions of transducers 130, pressure sensor 125, and noise sensor 202, or a sub-combination thereof, can be different than those illustrated and described.

According to an exemplary embodiment, detector 204 can include a DSP 209, similar to DSP 155, that can detect the presence or the absence of a leak or another type of an anomaly (e.g., noise other than a leak, such as noise produced by other sources (e.g., heating system, cooling system, trains, nearby construction, etc.)) based on acoustic energy detected by an acoustic sensor (e.g., a noise sensor 202 illustrated and described below), as described herein.

According to an exemplary embodiment, DSP 155/209 can include an algorithm or processing logic that performs spectral analysis. For example, the spectral analysis can include analysis related to one or multiple characteristics of the acoustic energy, such as frequency, amplitude, power, phase, envelope, and/or other characteristics of the acoustic signal. Spectral analysis can be performed, for example, to detect noise that indicates turbulence of fluid flow, which may be caused by a leak. In some examples, the detector 204 can determine, based on spectral analysis, that the acoustic energy detected by the noise sensor 202 is indicative of a level of turbulence greater than an expected level of turbulence, and therefore determine a high likelihood of a leak in the piping system. In some examples, the detector 204 can estimate a size of the leak and/or a proximity of the leak to the meter 200 based on the level of turbulence. The detector 104 can determine the expected level of turbulence can be based on factors such as a predicted flow rate of a resource through the pathway 120, a type of the resource, a temperature of the resource, and/or other factors.

According to some exemplary embodiments, DSP 155/209 can determine whether the spectral analysis indicates that the acoustic signal is indicative of a leak. For example, DSP 155/209 can make a binary determination (i.e., a leak versus no leak). According to other exemplary embodiments, DSP 155/209 can determine a degree of confidence to which the acoustic signal is indicative of a leak. For example, DSP 155/209 can be configured with a multitude of degrees or levels of confidence in which the acoustic signal can be representative of a leak. For example, DSP 155/209 can be configured with a ternary determination that can indicate a high degree of confidence, a moderate degree of confidence, or a low degree of confidence that the acoustic signal is indicative of a leak and a high degree of confidence, a moderate degree of confidence, or a low degree of confidence that the acoustic signal is not indicative of a leak. According to other examples, the number of various degrees can be different (e.g., a quaternary determination or higher, a binary determination (e.g., low or high), etc.).

According to some exemplary embodiments, DSP 155/209 can calculate the degree of confidence based on a weighting system associated with various spectral characteristics of a leak signature. For example, the frequency signature of the acoustic signal can be afforded a higher weight than the envelope of the acoustic signal. Additionally, or alternatively, the number of acoustic signal characteristics that match characteristics representative of a leak and the number of acoustic signal characteristics that do not match characteristics representative of a leak can contribute to the calculation of the degree of confidence to which the acoustic energy indicates a leak. According to other exemplary embodiments, DSP 155/209 can be similarly configured for determining whether the acoustic signal is indicative of a leak or not (i.e., the binary determination as mentioned above).

DSP 155/209 can analyze or evaluate the acoustic energy based on other values or information, such a flow measurement value (e.g., flow rate, flow velocity, etc.), a temperature value, a pressure value, pipe or conduit characteristics (e.g., material, diameter, etc.), leak characteristics, resource characteristics (e.g., density, absorption properties, etc.) and/or other context information of relevance, as described herein, that can influence acoustic signal analysis or complement the determination for detecting the presence or the absence of a leak or a degree of confidence of a leak.

According to an exemplary embodiment, DSP 155/209 can store a threshold value or values. For example, DSP 155/209 can store one or multiple threshold values pertaining to pressure drop, as described herein. According to various exemplary implementations, a pressure threshold value can be a single value or a range of values (e.g., minimum and maximum values, etc.). When pressure in the pathway 120 changes by an amount that satisfies the pressure threshold value, the DSP 155/209 can analyze the acoustic energy detected by the noise sensor 202 to evaluate the likelihood of a leak. In some examples, the DSP 155/209 selects an acoustic analytics process based on the measured pressure values.

According to some exemplary embodiments, the pressure threshold value can be correlated to other information, as described herein. For example, the pressure threshold value can correlate to an acoustic signature, a leak characteristic (e.g., a size of a leak, circumferential crack, longitudinal crack, a distance from a meter, an upstream leak, a downstream leak, etc.), a flow measurement value, a diameter of a pipe or a conduit, a resource characteristic, and the like, or a sub-combination thereof. For example, for a measured pressure value between a lower threshold and an upper threshold, the acoustic energy detected by the noise sensor 202 can be predicted to have a particular signature. Deviation of the acoustic energy from the particular signature can be indicative of a leak.

According to some exemplary embodiments, the pressure threshold value can be correlated to a probabilistic value. For example, the probability value can indicate a degree of certainty regarding whether the measured pressure value indicates a leak.

In some examples, the detector 150/204 can select the acoustic analytics process to perform an acoustic signature analysis based on the pressure values measured by the pressure sensors 125. The DSP 155/209 can store acoustic signatures, which can be indicative of a leak, that correlate to other information, such as different pressure threshold values or ranges, temperature threshold values or ranges, and other contextual information, as described herein, or a sub-combination thereof. The selected acoustic analytics process can be used to detect one or more acoustic signatures for leak detection. For example, according to such an embodiment, DSP 155/209 can use a pressure threshold, a temperature threshold, etc., as criteria to select an acoustic signature or acoustic signatures for comparison with and evaluation of one or multiple acoustic signals detected by an acoustic sensor (e.g., noise sensor 202 or transducer 130). In this way, DSP 155/209 can make a determination, based on the result of the evaluation, as to the presence or absence of a leak and/or identify another type of acoustic anomaly.

In some examples, the detector 150/204 selects a predicted acoustic signature based on a measured pressure value. The detector 150/204 can compare an acoustic signature measured by the noise sensor 202 to the predicted acoustic signature to determine a degree of similarity. In response to determining that the degree of similarity satisfying matching criteria, the detector 150/204 can determine that there is likely no leakage from the piping system. In response to determining that the degree of similarity does not satisfy the matching criteria, the detector 150/204 can determine that there is likely a leak from the piping system. In some examples, the detector 150/204 can estimate a size of the leak based on a degree of similarity between the predicted acoustic signature and the measured acoustic signature. A greater degree of similarity can be indicative of a smaller leak, while a lesser degree of similarity can be indicative of a larger leak. In some examples, the detector 150/204 can estimate a proximity of the leak based on a degree of similarity between the predicted acoustic signature and the measured acoustic signature. A greater degree of similarity can be indicative of a farther leak, while a lesser degree of similarity can be indicative of a nearer leak.

According to some exemplary embodiments, acoustic signature and threshold values (e.g., relating to pressure, temperature, other measurable criteria) may be dynamic. For example, acoustic signatures or templates can be updated or modified based on an artificial intelligence (AI) and/or a machine learning (ML) (AI/ML) model. In some examples, the ML model can be trained to recognize leaks in piping systems using acoustic signatures. In some examples, the ML model can be trained to recognize leaks in piping systems using pressure values and acoustic signatures. For example, the pressure signal measured by the pressure sensor 125 and the acoustic signal measured by the noise sensor 202 can be input to an ML model, which can output a determination of whether there is a leak in the piping system.

According to an exemplary embodiment, the AI/ML model can be implemented as a neural network model (NNM), a Generalized Linear Model (GLM), a Decision Tree, or another type of learning-based algorithm. According to an exemplary embodiment, the acoustic and pressure-based leak detection system can use an optimization algorithm, such as a reinforcement learning algorithm or another type of learning algorithm (e.g., supervised learning, etc.). The goal of the optimization can be configurable. For example, the optimization can relate to leak detection. For example, the ML model can be trained to optimize accuracy of detecting leaks while minimizing false alerts.

According to some exemplary embodiments, the pressure threshold value can be a pressure value indicative of a leak. In this way, when a measured pressure value is equal to or below the pressure threshold value, DSP 155/209 can determine that the measured pressure value is indicative of a leak. According to other exemplary embodiments, the pressure threshold value can be a pressure value not indicative of a leak. In this way, when a measured pressure value is equal to or above the pressure threshold value, DSP 155/209 can determine that the measured pressure value is not indicative of a leak.

According to some exemplary embodiments, the pressure threshold values can be correlated to different degrees of confidence indicative of a leak in a manner similar to that explained regarding the acoustic signal.

DSP 155/209 can compare a measured pressure value received via pressure sensor 125 to a pressure threshold value to determine whether the measured pressure value is indicative of a leak, as described herein. According to various exemplary embodiments, DSP 155/209 can make this determination independent of other criteria used (e.g., acoustic analysis, analysis of other correlated contextual information, etc.) or dependent on determined values associated with other criteria used (e.g., acoustic analysis, analysis of other correlated contextual information, etc.). For example, according to various exemplary embodiments, DSP 155/209 can determine whether the measured pressure value is indicative of a leak when acoustic analysis indicates a leak or when the acoustic analysis is equal to or below a certain degree of confidence of a leak, as described herein. For example, when the result of the acoustic analysis indicates that the acoustic signal indicates a leak to a medium degree of confidence or below a medium degree of confidence (or some other level or degree, such as low, etc.), DSP 155/209 can further apply the evaluation of pressure to make a determination as to the presence or the absence of a leak.

According to an exemplary embodiment, DSP 155/209 can further determine a location and/or direction of the leak or other type of acoustic anomaly (e.g., relative to the meter). For example, when DSP 155/209 determines that there is a leak or a certain level or degree of confidence of a leak, DSP 155/209 can determine the location of the leak, the direction of the leak (e.g., upstream or downstream, inlet 110 or outlet 115, etc., relative to meter 100, etc.), or both. According to an exemplary embodiment, when multiple sensors (e.g., of the same type, of different types, or both) are used to detect the leak, variation between each respective signal can form a basis in determining the location and/or the direction of the leak, among other features associated with the leak, as described herein. In some examples, the noise sensor 202 includes an array of multiple sensor elements. A time difference between receipt of acoustic energy by different elements of the array can be used to estimate an incident angle of the acoustic energy. The detector 204 can determine a location of the leak based on the incident angle. In some examples, the detector 204 can determine a location of the leak based on an amplitude of the acoustic energy detected by the noise sensor 202.

According to an exemplary embodiment, detector 204 can invoke a remedial procedure when the presence of the leak or a certain degree of confidence of a leak is detected, as described herein. For example, meter 100 can generate and transmit an alert message or another type of notification to a backend system of the distribution network. In some examples, the meter 100 can cause a shut-off valve to close, such as by transmitting an instruction to the shut-off valve that causes the shut-off valve to close. According to an exemplary embodiment, the message or notification can include data characteristic of the leak. For example, the data can include data pertaining to the frequency spectrum, pressure, and other context information, or a sub-combination thereof associated with the leak. The data can further include location and/or direction information pertaining to the leak. The data can also include position data of meter 100. For example, the position data can include a Global Positioning System (GPS) coordinate (e.g., latitude, longitude), state, city, zip code, street address, or the like. The data can also include a timestamp indicating a date (e.g., month, day, and year) and a time (e.g., 2:00 pm) or a time period (e.g., 5:00 pm – 5:10 pm). DSP 155 can also store leak information in a memory.

According to some exemplary embodiments, meter 100 can communicate with an external device (e.g., an application server) via the MIU of meter 100 and a network (e.g., a wireless network). Although not illustrated, the external device can further analyze leak information generated by DSP 155 based on a statistical model, an AI/ML model, and/or another type of analytics. The external device can be configured to compare, evaluate, and/or compile the leak information associated with meter 100 with leak information associated with other meters. The external device can generate analytic information pertaining to leak detection and localization based on the evaluated leak information of meters. For example, the external device can generate, update, modify, validate, etc., threshold acoustic values and/or spectral characteristics (e.g., frequency, amplitude, envelope, power, density, phase, etc., within a bandwidth of interest, etc.) related to noise indicative of the presence or the absence of a leak or another anomaly. The external device can also generate, update, modify, validate, etc., the acoustic values and/or spectral characteristics in relation to different flow rates, temperature values, pressure values, conduit or pipe material, diameter of pipe, leak type (e.g., circumferential crack (e.g., in a pipe or another element of a distribution system), longitudinal crack (e.g., in a pipe or another element of a distribution system), valve leak, etc.) and/or other types of factors. The external device can also further evaluate position and time information associated with the leak information obtained from meters situated in a given area.

According to some exemplary embodiments, detector 150 and/or detector 204 can be triggered to provide the acoustic and pressure-based leak detection system in response to evaluated values of the flow measurement service. For example, when the flow rate is low, near zero, or zero, the controller can invoke the acoustic and pressure-based leak detection system. Additionally, or alternatively, the acoustic and pressure-based leak detection system can be triggered when flow rates other than low, near zero, or zero are detected. In this regard, the acoustic and pressure-based leak detection system can collect noise samples that correlate to different flow rates, as described herein.

According to an exemplary embodiment, detector 150 and/or detector 204 can analyze electrical signals differently depending on the service provided. For example, detector 150 and/or detector 204 can select an algorithm or processing logic that can calculate TOF and other values relating to flow measurement, as described herein. Contrastingly, detector 150 and/or detector 204 can select an algorithm or processing logic that can detect the presence or the absence of a leak or other type of anomaly and determine the localization of the leak or other type of acoustic anomaly, as described herein. According to some exemplary embodiments, electrical signals detected simultaneously by transducers 130, pressure sensors 125, and/or noise sensors 202 can enable detector 150 and/or detector 204 to deduce or estimate a direction (relative to meter 100 or meter 200) of the leak or other acoustic anomaly. For example, the incident angle of acoustic energy indicative of turbulence caused by a leak can be used to estimate a location of the leak. In some examples, the pressure sensor 125 and/or noise sensor 202 include an array of sensing elements, and a time difference between detections of the sensing elements can be used to determine a direction of the leak. This can be useful in the context of district meters and point-of-use meters. Detector 150 and/or detector 204 can further include sampling the signals associated with flow measurement (e.g., ultrasonic signals transmitted and received by the transducers 130) at a higher rate than the signals directed to leak detection (e.g., acoustic energy detected by the noise sensor 202 and/or the transducers 130), as described herein.

The MIU can transmit and receive messages via a wireless network, such as a Long Range wide area network (LoRaWAN), a Sigfox low-power WAN (LPWAN), an Ultra Narrow Band (UNB) network, an Ingenu machine network, an Evolved UMTS Terrestrial Radio Access Network (E-UTRAN) (e.g., a Fourth Generation radio access network (4G RAN)), a 4.5G RAN, etc.), a Fifth Generation (5G) RAN, a future generation RAN (e.g., a 5G Advanced RAN, a Sixth Generation (6G) RAN, a Seventh Generation (7G) RAN, or the like), a public land mobile network (PLMN), a mobile transceiver network (e.g., a mobile or handheld user device (e.g., operated by a user or a technician associated with a utility company, such as a water company), a vehicle mounted device, or another suitable mobile device (e.g., a drone, etc.)), a proprietary wireless network (e.g., owned and operated by a utility company (e.g., a water utility company, etc.), a wireless network that supports an AMR system, an AMI system, an AMS, etc.), a Wi-Fi® network, and Bluetooth® network, or a subset of such networks or use of other known wireless networks and/or technologies not specifically mentioned herein. The MIU can also transmit and receive messages via a wired connection. For example, the technician can interface with the meter via the MIU via a cable or other form of connector. The MIU can be integrated with the meter or provided as a separate device from the meter, but communicatively coupled with the meter.

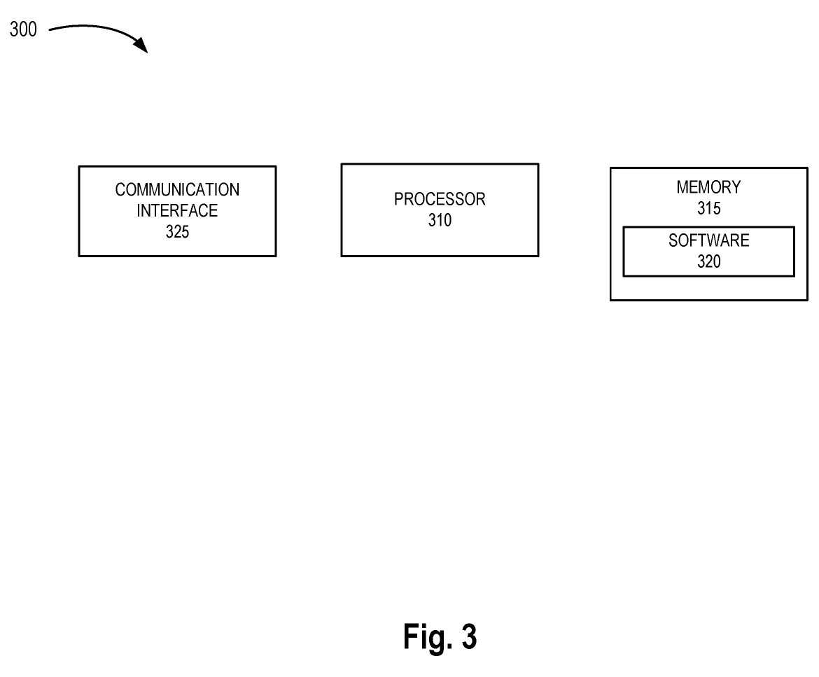

The controller of meter 100/200 can include a processor and/or logic circuitry that executes one or more processes/functions. The controller can include ports for receiving and sending data, including sending control instructions and receiving control acknowledgements, from a component of detector 150 or detector 204. The controller can also communicate with other components (e.g., the MIU, etc.) of meter 100 and meter 200. Components of the MIU and the controller, as well as other components of the meter are further described and illustrated in FIG. 3.

FIG. 3 is a diagram illustrating exemplary components 300 that can be included in a meter, such as flow consumption meter, or another type of apparatus as described herein. For example, one or more of the components 300 illustrated in FIG. 3 can be included in detector 150/204, components external from detector 150/204, such as the MIU and the controller, or external from meter 100/200 but communicatively coupled to the meter 100/200 (e.g., the MIU). As illustrated in FIG. 3, the components 300 can include a processor 310, a memory 315, and a communication interface 325. According to some exemplary embodiments, memory 315 can store software 320, as illustrated in FIG. 3. According to other embodiments, fewer components, additional components, and/or different components than those illustrated in FIG. 3 and described herein, can be implemented. For example, meter 100/200 or another type of apparatus can include an input component, an output component, or both. For example, the input component can include a switch, a display, an input port, or another type of component that enables another device or a user to provide an input. Additionally, for example, the output component can include an output port, a light, a display, or another type of component that enables another device or a user to receive an output.

Processor 310 includes one or multiple processors, microprocessors, microcontrollers, application specific integrated circuits (ASICs), programmable logic devices, chipsets, field-programmable gate arrays (FPGAs), application specific instruction-set processors (ASIPs), system-on-chips (SoCs), central processing units (CPUs) (e.g., one or multiple cores), neural processing units (NPUs), quantum processors, future generation processor, and/or some other type of component that interprets and/or executes instructions and/or data. Processor 310 can be implemented as hardware (e.g., a microprocessor, etc.), a combination of hardware and software (e.g., a SoC, an ASIC, etc.), can include one or multiple memories (e.g., cache, etc.), etc. By way of example, DSP 155/209, the MIU, and the controller can each include processor 310 or a same processor 310 can be used (e.g., shared) by two or more of these components.

Memory 315 includes one or multiple memories and/or one or multiple other types of storage mediums. For example, memory/storage 315 can include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically erasable PROM (EEPROM), a solid state memory, a flash memory, or the like. By way of example, DSP 155/209, the MIU, and the controller can each include memory 315 or shared by two or more of these components. Memory 315 can store data and/or software 320, for example.

Software 320 includes an application or a program that provides a function and/or a process. As an example, with reference to DSP 155/209 and/or the controller, software 320 can include an application that, when executed by processor 310, provides a function and/or a process of the acoustic and pressure-based leak detection system, as described herein. Software 320 can include software, firmware, middleware, microcode, hardware description language (HDL), and/or another form of instruction.

Communication interface 325 permits meter 100/200 to communicate with other devices, networks, systems, and/or the like. Communication interface 325 can include a wireless interface, an optical interface, and/or a wired interface. For example, communication interface 325 can include one or multiple transmitters and receivers, or transceivers. Communication interface 325 can operate according to a protocol stack and a communication standard. Communication interface 325 can support one or multiple transmission/reception configurations. The MIU can include communication interface 325, for example.

Meter 100/200 can be configured to perform a process and/or a function, as described herein, in response to processor 310 executing software 320 stored by memory 315. For example, the instructions stored by memory 315 cause processor 310 to perform a function or a process described herein. According to some exemplary embodiments, instructions can be read into memory 315 via communication interface 325. For example, meter 100/200 can receive instructions from a backend device associated with a flow distribution network. Alternatively, for example, according to other implementations, meter 100/200 can be configured to perform a function or a process described herein based on the execution of hardware (processor 310, etc.).

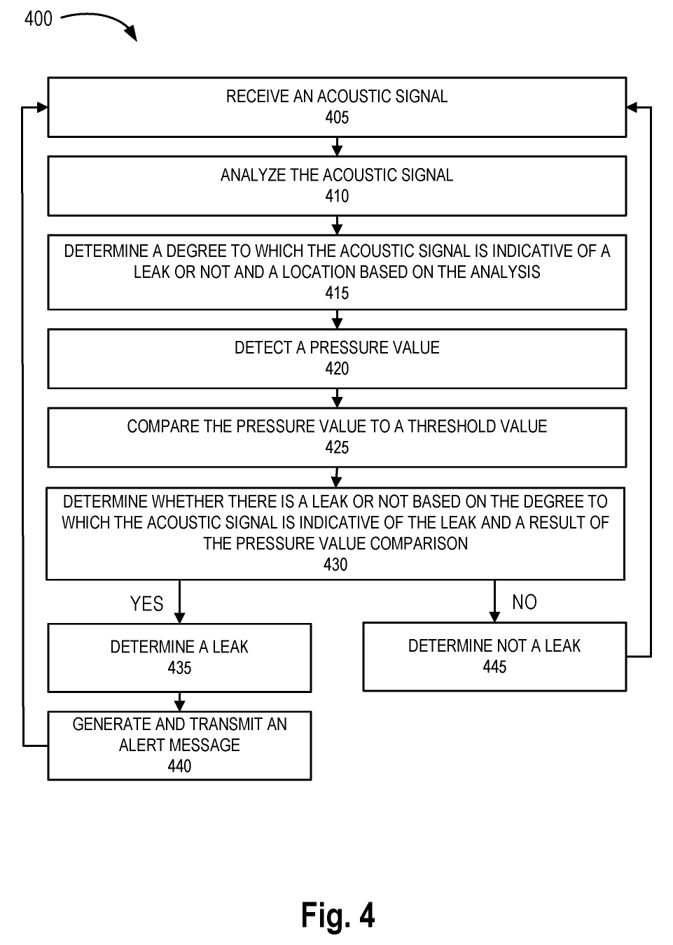

FIG. 4 is a flow diagram illustrating an exemplary process 400 of an exemplary embodiment of the acoustic and pressure-based leak detection system. According to an exemplary embodiment, meter 100 or meter 200 can perform steps of process 400. According to other exemplary embodiments, a non-meter (e.g., another type of apparatus which can be included in a resource distribution system, a server in a cloud, etc.) can perform steps of process 400. According to an exemplary implementation, a detector, such as detector 150/204 can perform, in whole or in part, process 400. According to an exemplary implementation, processor 310 can execute software to perform one or more steps illustrated and described in relation to FIG. 4. Alternatively, a step illustrated in FIG. 4 and described herein can be performed by execution of only hardware. For purposes of description, process 400 is described as performed by meter 100/200.

Referring to FIG. 4, in block 405, meter 100/200 can receive an acoustic signal. For example, transducer 130 and/or noise sensor 202 can detect an acoustic wave. Transducer 130 and/or noise sensor 202 can provide the acoustic signal to detector 150/204 of meter 100/200.

In block 410, meter 100/200 can analyze the acoustic signal. For example, detector 150/204 can select an acoustic analytics process for analyzing the acoustic signal. In some examples, the acoustic analytics process includes performing spectral analysis of the acoustic signal. The spectral analysis can include analysis of different characteristics associated with the acoustic signal, such as frequency, amplitude, power, phase, envelope, power spectral density (PSD), frequency domain, and the like. Detector 150/204 can provide other types of signal processing, such as filtering, gain, cross-correlation, autocorrelation, smoothing, and other known processes pertaining to noise evaluation and signal processing in general.

In block 415, meter 100/200 can determine a degree of confidence to which the acoustic signal is indicative of a leak and a location based on the analysis. For example, detector 150/204 can determine the degree of confidence (e.g., low, medium, high, or some other level) to which the acoustic signal is indicative of the leak. According to some exemplary embodiments, detector 150/204 can calculate the degree of confidence based on a weighting system associated with various spectral signal characteristics, as described herein. According to an exemplary embodiment, detector 150/204 can determine the degree of confidence based on other contextual information associated with the acoustic signal and information obtained from other sensors (e.g., temperature, pressure, etc.), or a subset thereof, as described herein. For example, a temperature sensor can measure the temperature external from the meter (e.g., ambient or air temperature, temperature of the resource (e.g., water temperature, etc.) or both. Detector 150/204 can also determine the location of the leak or other noise source, as described herein.

In block 420, meter 100/200 can detect a pressure value. For example, pressure sensor 125 can detect a pressure associated with a resource, such as water or another type of resource, as described herein.

In block 425, meter 100/200 can compare the pressure value to a threshold value. For example, detector 150/204 can select the threshold value based on a flow value (e.g., flow rate, flow velocity, etc.), contextual information (e.g., temperature, etc.), or another criterion. Detector 150/204 can compare the measured pressure value to the threshold value. Based on a result of the comparison, detector 150/204 can determine whether the pressure value is indicative of a leak.

In block 430, meter 100/200 can determine whether there is a leak based on the degree of confidence to which the acoustic signal is indicative of the leak and a result of the pressure value comparison. For example, detector 150/204 can evaluate the results of the spectral analysis and pressure analysis, independently, in combination, or both to determine the presence or absence of a leak. According to some exemplary embodiments, detector 150/204 can evaluate the results based on a weighting system depending on various criteria. For example, for acoustic signal analysis, depending on the presence or absence of noise (e.g., a signal-to-noise ratio (SNR) value) associated with the acoustic signal and the number of sensors and readings obtained, detector 150/204 can afford a greater weight or a lesser weight relative to the pressure-related information collected and analyzed. According to other exemplary embodiments, detector 150/204 can evaluate the degrees associated with the acoustic signal and the pressure information where certain combinations of degrees can indicate the presence or the absence of a leak, as described herein.

In block 435, when meter 100/200 determines there is a leak, in block 440, meter 100/200 can generate and transmit an alert message. For example, the alert message can include leak information, as described herein. Process 400 can continue back to block 405.

In block 445, when meter 100/200 determines that there is not a leak, process 400 can continue back to block 405. For example, meter 100/200 can determine not to generate or transmit the alert message.

FIG. 4 illustrates an exemplary process 400 of the acoustic and pressure-based leak detection system, however, according to other embodiments, process 400 can include additional operations, fewer operations, and/or different operations than those illustrated in FIG. 4 and described herein. For example, the detector can receive a control signal from the controller that can cause the detector to reconfigure in a particular mode of operation (e.g., leak detection to flow measurement, or vice versa). Additionally, or alternatively, as described herein, process 400 can include flow information and/or leak information transmitted to an external device via the MIU, as described herein. Process 400 can further include processes described in relation to leak detection performed by an external device (e.g., an application server), as described herein.

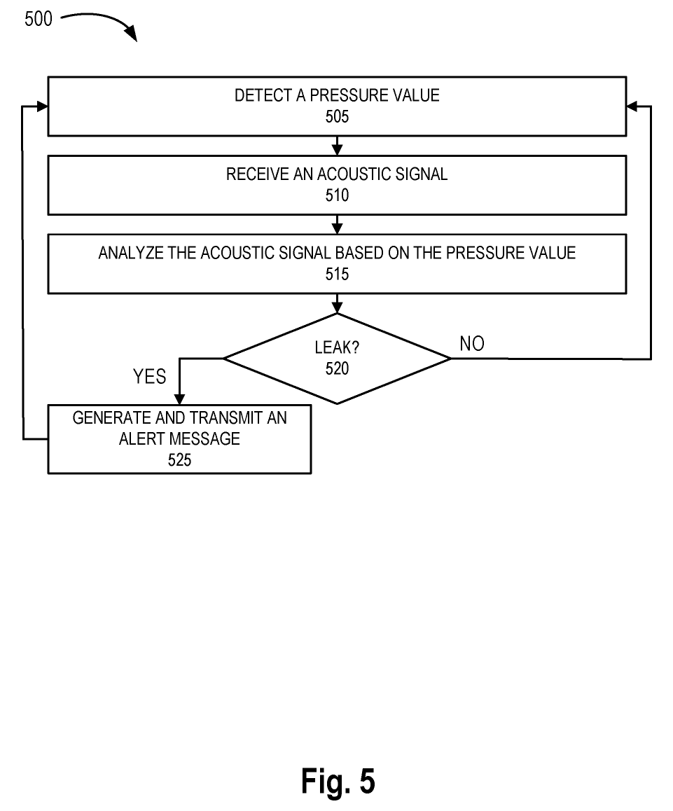

FIG. 5 is a flow diagram illustrating an exemplary process 500 of an exemplary embodiment of the acoustic and pressure-based leak detection system. According to an exemplary embodiment, meter 100 or meter 200 can perform steps of process 500. According to other exemplary embodiments, a non-meter (e.g., another type of apparatus which can be included in a resource distribution system, a server in a cloud, etc.) can perform steps of process 500. According to an exemplary implementation, a detector, such as detector 150/204 can perform, in whole or in part, process 500. According to an exemplary implementation, processor 310 can execute software to perform one or more steps illustrated and described in relation to FIG. 5. Alternatively, a step illustrated in FIG. 5 and described herein can be performed by execution of only hardware. For purposes of description, process 500 is described as performed by meter 100/200.

Referring to FIG. 5, in block 505, meter 100/200 can detect a pressure value. For example, pressure sensor 125 can detect one or multiple pressure values associated with a resource, such as water or another type of resource, during a time period. According to some exemplary embodiments, meter 100/200 can measure other values, such as temperature.

In block 510, meter 100/200 can receive an acoustic signal. For example, transducer 130 and/or noise sensor 202 can detect an acoustic wave. Transducer 130 and/or noise sensor 202 can provide one or multiple acoustic signals to detector 150/204 of meter 100/200.

In block 515, meter 100/200 can select an acoustic analytics process for analyzing the acoustic signal based on the pressure value. For example, detector 150/204 can determine to perform analyze the acoustic signal in response to determining that a measured pressure value deviates from an expected pressure value. In some examples, the detector 150/204 can select to perform an acoustic analytics process in the form of spectral analysis of the acoustic signal based on the corresponding pressure value(s). The detector 150/204 can select a predicted acoustic signature of an acoustic signal that corresponds to the pressure values, and compare a measured acoustic signature of the acoustic signal to the predicted acoustic signature. Deviation of the measured acoustic signature from the predicted acoustic signature can be indicative of a leak or other anomaly. In response to detecting a deviation of the measured acoustic signature from the predicted acoustic signature that is greater than a threshold deviation, the detector 150/204 can determine that there is likely a leak in the piping system.

In some examples, the pressure value can match a predicted pressure value, and the detector 150/204 can determine not to analyze the acoustic signal. For example, the pressure value may remain consistent over time within a threshold tolerance. In response, the detector 150/204 can determine that a leak is unlikely, and therefore determine not to analyze the acoustic signal.

In some examples, the pressure value can deviate from a predicted pressure value, and the detector 150/204 can determine to analyze the acoustic signal in response to detecting the deviation. For example, the pressure value may be expected to be within a specified range of pressure values when a resource is passing through the pathway 120. The predicted pressure value can be determined based on factors such as an expected flow rate of the resource through the pathway 120, an expected or measured temperature of the resource in the pathway 120, a type of the resource, and/or other factors. In response to the pressure value deviating from the specified range of values, the detector 150/204 can determine to analyze the acoustic signal to verify whether there is a leak in the piping system. By performing the verification with another type of sensor, the accuracy of the leak detection can be improved.

According to another example, detector 150/204 can perform spectral analysis of the acoustic signal based on the corresponding values, such as pressure and temperature. The spectral analysis can include analysis of different characteristics associated with the acoustic signal, such as frequency, amplitude, power, phase, envelope, power spectral density (PSD), frequency domain, and the like. Detector 150/204 can provide other types of signal processing, such as filtering, gain, cross-correlation, autocorrelation, smoothing, and other known processes pertaining to noise evaluation and signal processing in general. According to an exemplary embodiment, detector 150/204 can perform the spectral analysis based on contextual information, such as characteristics of pipe/conduit (e.g., material, diameter, etc.), corresponding flow measure value(s), etc., as described herein. According to an exemplary embodiment, detector 150/204 can include comparing the acoustic signal(s) to corresponding acoustic signature templates associated with threshold pressure, temperature, and/or contextual attributes.

According to another exemplary embodiment, detector 150/204 can select one or multiple algorithms that provide a spectral analysis in view of pressure, temperature, and/or the like, as described herein. For example, detector 150/204 can include evaluating a peak frequency and/or another spectral characteristics of the acoustic signal in view of the corresponding pressure value, temperature value, and/or the like, as described herein. Deviations of measured values of acoustic signal characteristics from predicted values of acoustic signal characteristics, given the measured pressure and/or temperature, can be indicative of a leak.

In block 520, meter 100/200 can determine whether there is a leak based on the analysis. For example, detector 150/204 can determine whether or not there is a leak based on a degree of confidence to which the acoustic signal is indicative of the leak. The detector 150/204 can determine whether a measured acoustic signal has characteristics that satisfy similarity criteria for matching predicted acoustic characteristics, based on the measured pressure and/or temperature. According to various exemplary embodiments, detector 150/204 can be configured with binary, ternary, etc., determinations of degrees, as described herein. According to another exemplary embodiment, detector 150/204 can make a binary determination between there is a leak or there is not a leak, as described herein.

Detector 150/204 can further determine a location, size, and/or direction of the leak or other type of acoustic anomaly (e.g., relative to the meter). For example, when detector 150/204 determines that there is a leak or a certain level or degree of confidence of a leak, detector 150/204 can determine the location of the leak, the direction of the leak (e.g., upstream or downstream, inlet 110 or outlet 115, etc., relative to meter 100/200, etc.), or both. According to an exemplary embodiment, when multiple sensors (e.g., of the same type, of different types, or both) are used to detect the leak, variation between each respective signal can form a basis in determining the location and/or the direction of the leak, among other features associated with the leak, as described herein.

When meter 100/200 determines there is a leak (block 520-YES), meter 100/200 can generate and transmit an alert message (block 525). For example, the alert message can include leak information, as described herein. Process 500 can continue back to block 505.

When meter 100/200 determines there is not a leak (block 520-NO), process 500 can continue back to block 505. For example, meter 100/200 can omit generating and transmitting the alert message.

FIG. 5 illustrates an exemplary process 500 of the acoustic and pressure-based leak detection system, however, according to other embodiments, process 500 can include additional operations, fewer operations, and/or different operations than those illustrated in FIG. 5 and described herein. For example, the detector can receive a control signal from the controller that can cause the detector to reconfigure in a particular mode of operation (e.g., leak detection to flow measurement, or vice versa). Additionally, or alternatively, as described herein, process 500 can include flow information and/or leak information transmitted to an external device via the MIU, as described herein. Process 500 can further include processes described in relation to leak detection performed by an external device (e.g., an application server), as described herein.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

Embodiments described herein may be implemented in many different forms of hardware or software executed by hardware. For example, a process, a function, a step of a process or the like, in whole or in part, may be implemented as “logic,” a “component,” an “element,” a “circuit” (e.g., digital, analog, integrated, or combination) (referred to as “hardware”). The hardware may include, for example, processor 310, transducer 130, pressure sensor 125, noise sensor 202, detector 150, detector 204, and/or other types of hardware, as described herein, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Spatially relative terms, such as “beneath,” “below,” “lower,” “above,” “upper,” “top”, “bottom” and the like, may be used herein for ease of description to describe a relationship between one element to another element as illustrated in the Figures. The spatially relative terms are intended to encompass different orientations of the device in use or operation, in addition to the use or the operation depicted in the figures. For example, if the device in the Figure is turned over, an element described as “below” or “beneath” another element or another feature would then be oriented “above” the other element or the other feature. Thus, the exemplary terms “below” or “beneath” may encompass both an orientation of above and below depending on the orientation of the device. In the instance that the device may be oriented in a different manner (e.g., rotated at 90 degrees or at some other orientation), the spatially relative terms used herein should be interpreted accordingly.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated.

Additionally, embodiments described herein may be implemented as a non-transitory computer-readable storage medium that stores data and/or information, such as instructions, software, firmware, microcode, source code, object code, program code, a data structure, a program module, an application, a script, or other known or conventional form suitable for use in a computing environment. The program code, instructions, application, etc., is readable and executable by a processor (e.g., processor 310) of a device, such as a meter or another type of apparatus.

No element, act, or instruction set forth in this description should be construed as critical or essential to the embodiments described herein unless explicitly indicated as such.

All structural and functional equivalents to the elements of the various aspects set forth in this disclosure that are known or later come to be known to those of ordinary skill in the art are expressly incorporated herein by reference and are intended to be encompassed by the claims.

What is claimed is:

1. A meter comprising:
an inlet attachable to a piping system;
an outlet attachable to the piping system;
a passageway between the inlet and the outlet;
an acoustic sensor;
a pressure sensor; and
a detector, wherein the detector is configured to:
receive a first signal from the pressure sensor;
receive a second signal from the acoustic sensor;
select an acoustic analytics process based on a pressure value associated with the first signal;
analyze the second signal based on the acoustic analytics process;
detect a leak in the piping system based on the analysis; and
generate and transmit an alert in response to detecting the leak in the piping system.

2. The meter of claim 1, wherein the detector is further configured to:
determine a location of the leak relative to the meter based on a direction of sound detected by the acoustic sensor.

3. The meter of claim 1, wherein the acoustic analytics process comprises comparing spectral analysis of the second signal to a predicted spectral analysis of the second signal, wherein the predicted spectral analysis of the second signal is based on the pressure value.

4. The meter of claim 1, wherein detecting the leak comprises selecting a degree of confidence of the leak from a ternary determination of degrees of confidence or a quaternary determination of degrees of confidence.

5. The meter of claim 1, wherein the detector is configured to select the acoustic analytics process based on the pressure value and a temperature value associated with the first signal.

6. The meter of claim 1, wherein the detector is further configured to calculate a flow measurement value for flow of a resource through the passageway.

7. The meter of claim 1, wherein analyzing the second signal based on the acoustic analytics process is responsive to determining that the pressure value associated with the first signal does not satisfy criteria for matching an expected pressure value.

8. The meter of claim 1, wherein the alert includes data pertaining to the analysis of the second signal.

9. The meter of claim 1, wherein the meter is a water meter.

10. The meter of claim 1, wherein the acoustic sensor comprises an ultrasonic transducer.

11. A method for monitoring leakage in a piping system, the method comprising:
receiving, by a detector of a meter, a first signal from a pressure sensor, wherein the meter comprises an inlet attachable to the piping system, an outlet attachable to the piping system, and a passageway between the inlet and the outlet;
receiving, by the detector, a second signal from an acoustic sensor;
selecting, by the detector, an acoustic analytics process based on a pressure value associated with the first signal;
analyzing, by the detector, the second signal based on the acoustic analytics process;
detecting a leak in the piping system based on the analysis; and
generating and transmitting, by the detector, an alert in response to detecting the leak in the piping system.

12. The method of claim 11, further comprising:
determining, by the meter, a location of the leak relative to the meter based on a direction of sound detected by the acoustic sensor.

13. The method of claim 11, wherein the acoustic analytics process comprises comparing spectral analysis of the second signal to a predicted spectral analysis of the second signal, wherein the predicted spectral analysis of the second signal is based on the pressure value.

14. The method of claim 11, wherein detecting the leak comprises:
selecting, by the detector, a degree of confidence of the leak from a ternary determination of degrees or a quaternary determination of degrees of confidence.

15. The method of claim 11, further comprising:
calculating, by the detector, a flow measurement value for flow of a resource through the passageway.

16. The method of claim 11, wherein the selecting further comprises:
selecting, by the detector, the acoustic analytics process based on the pressure value and a temperature value associated with the first signal.

17. The method of claim 11, wherein analyzing the second signal based on the acoustic analytics process is responsive to determining that the pressure value associated with the first signal does not satisfy criteria for matching an expected pressure value.

18. The method of claim 11, wherein the meter comprises a water meter.

19. The method of claim 11, wherein the acoustic sensor comprises an ultrasonic transducer.

20. A system for monitoring leakage in a piping system, the system comprising:
a pressure sensor;
an acoustic sensor; and
a computing device communicably coupled to the pressure sensor and the acoustic sensor, the computing device configured to perform operations comprising:
receiving a first signal from the pressure sensor;
receiving a second signal from the acoustic sensor;
selecting an acoustic analytics process based on a pressure value associated with the first signal;
analyzing the second signal based on the acoustic analytics process;
detecting a leak in the piping system based on the analysis; and
generating and transmitting an alert in response to detecting the leak in the piping system.
